(19) United States
(12) Patent Application Publication
(10) Pub. No.: US 2024/0371130 A1
(43) Pub. Date: Nov. 7, 2024

(54) INFORMATION PROCESSING APPARATUS, INFORMATION PROCESSING METHOD, AND STORAGE MEDIUM

(71) Applicant: NEC Corporation, Tokyo (JP)

(72) Inventors: Tatsuya FUJIMOTO, Tokyo (JP); Hidemi Noguchi, Tokyo (JP); Junichi Abe, Tokyo (JP)

(73) Assignee: NEC Corporation, Tokyo (JP)

(21) Appl. No.: 18/645,803

(22) Filed: Apr. 25, 2024

(30) Foreign Application Priority Data
May 1, 2023 (JP) 2023-078793

(51) Int. Cl. G06V 10/762; G01S 17/89

(52) U.S. Cl. CPC G06V 10/762; G01S 17/89

(57) ABSTRACT

An information processing apparatus of the present disclosure includes: a classifying unit that classifies three-dimensional point cloud data including distance values to a target in a specified region into one or more clusters based on the distance values; and a determining unit that determines the cluster to adopt based on the distribution of the distance values of the three-dimensional point cloud data included by the cluster obtained by the classification.

### INCORPORATION BY REFERENCE

This application is based upon and claims the benefit of priority from Japanese patent application No. 2023-078793, filed on May 11, 2023, the disclosure of which is incorporated herein in its entirety by reference.

### TECHNICAL FIELD

The present disclosure relates to an information processing apparatus, an information processing method, and a storage medium.

### BACKGROUND ART

It is generally known that a three-dimensional point cloud obtained by LiDAR (Light Detection And Ranging) contains a noise point cloud. The generation of a noise point cloud results from the ranging accuracy of a LiDAR device, and erroneous ranging as a result of the recognition of a noise signal as a reflected pulse by factors such as an object moving during measuring, reflection on a metal surface and transmission on a glass surface, and low light intensity when a light pulse transmitted from a LiDAR device is reflected from a target object and received.

In particular, it is thought that when the intensity of the received light is low, erroneous ranging occurs in a process as shown below. In a LiDAR device, a reflected light pulse reflected thereby is photoelectrically converted by an optical receiver inside the device and processed as an electrical signal. An arithmetic logic unit of the LiDAR device calculates the distance to a target object using this electrical signal. However, when the reception intensity of the reflected light is low, noise signals originating from the device and an external factor are added to a small signal waveform and the signal waveform is thereby disturbed, resulting in erroneous ranging and a decrease in ranging accuracy.

On the other hand, such a noise point cloud can be removed by a point cloud processing method such as an isolated point removal filter. For example, Patent Literature 1 proposes a method of removing, from point cloud data, a point whose Euclidean distance to a neighboring point is equal to or more than a threshold value as a noise point. Patent Literature 1 also proposes a method of performing clustering on a point cloud based on variation in laser reflection intensity and separating and removing a reflection point other than a target object.
Patent Literature 1: Japanese Unexamined Patent Application Publication No. JP-A 2018-173749

However, the abovementioned technique described in the prior technique literature causes a problem that, in a situation where noise point clouds are continuous and dense in a region where many noise point clouds are likely to be generated, such noise point clouds cannot be completely removed and remain. Moreover, with the clustering method using the reflection intensity of laser, it is difficult to discriminate a noise point cloud resulting from the ranging accuracy of a LiDAR device and, in the case of ranging of a distant object, both a reflection signal from the object and a noise signal are weak and hence it is difficult to classify the signals. Thus, the technique disclosed in the prior technique literature has a problem that it is difficult to remove noise with accuracy from three-dimensional point cloud data.

### SUMMARY OF THE INVENTION

Accordingly, an object of the present disclosure is to provide an information processing apparatus that can solve the abovementioned problem that it is difficult to remove noise with accuracy from three-dimensional point cloud data.

An information processing apparatus as an aspect of the present disclosure includes: a classifying unit that classifies three-dimensional point cloud data including distance values to a target in a specified region into one or more clusters based on the distance values; and a determining unit that determines the cluster to adopt based on a distribution of the distance values of the three-dimensional point cloud data included by the cluster obtained by the classification.

Further, an information processing method as an aspect of the present disclosure includes: classifying three-dimensional point cloud data including distance values to a target in a specified region into one or more clusters based on the distance values; and determining the cluster to adopt based on a distribution of the distance values of the three-dimensional point cloud data included by the cluster obtained by the classification.

Further, a program as an aspect of the present disclosure includes instructions for causing a computer to execute processes to: classify three-dimensional point cloud data including distance values to a target in a specified region into one or more clusters based on the distance values; and determine the cluster to adopt based on a distribution of the distance values of the three-dimensional point cloud data included by the cluster obtained by the classification.

With the configurations as described above, the present disclosure enables accurate removal of noise from three-dimensional point cloud data.

### BRIEF DESCRIPTION OF DRAWINGS

FIG. 1 is a view showing the state of acquisition of three-dimensional point cloud data;

FIG. 2 is a view showing the state of acquisition of three-dimensional point cloud data;

FIG. 3 is a block diagram showing the configuration of a point cloud processing apparatus in a first example embodiment of the present disclosure;

FIG. 4 is a view showing the state of processing by the point cloud processing apparatus disclosed in FIG. 3;

FIG. 5 is a view showing the state of processing by the point cloud processing apparatus disclosed in FIG. 3;

FIG. 6 is a flowchart showing the operation of the point cloud processing apparatus disclosed in FIG. 3;

FIG. 7 is a view showing the state of processing by a point cloud processing apparatus in a second example embodiment of the present disclosure;

FIG. 8 is a flowchart showing the operation of the point cloud processing apparatus in the second example embodiment of the present disclosure;

FIG. 9 is a block diagram showing the hardware configuration of an information processing apparatus in a third example embodiment of the present disclosure; and

FIG. 10 is a block diagram showing the configuration of the information processing apparatus in the third example embodiment of the present disclosure.

### EXAMPLE EMBODIMENT

### First Example Embodiment

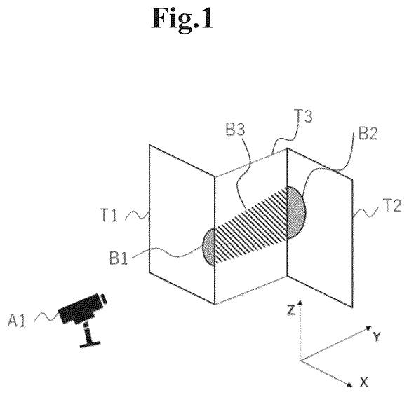

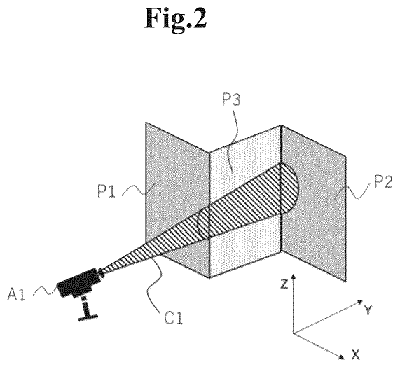

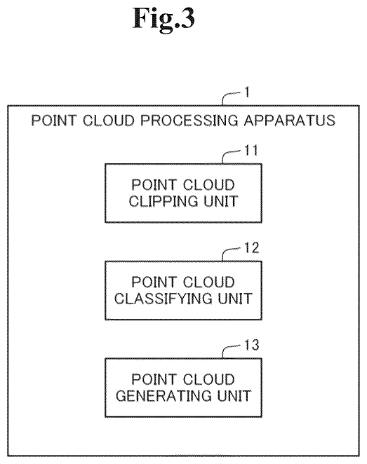

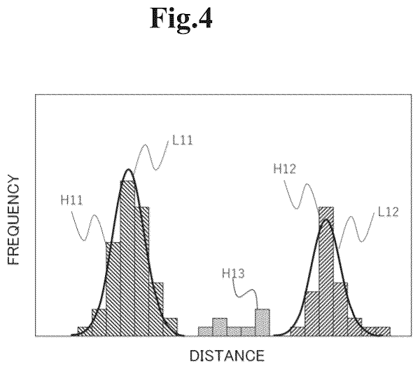

A first example embodiment of the present disclosure will be described with reference to FIGS. 1 to 6. FIGS. 1 and 2 are views for describing the state of acquisition of three-dimensional point cloud data. FIG. 3 is a view for describing the configuration of a point cloud processing apparatus, and FIGS. 4 to 6 are views for describing the processing operation of the point cloud processing apparatus.

The point cloud processing apparatus in the present disclosure is used for removing a point cloud that can be determined to be a noise point cloud from three-dimensional point cloud data including the value of a distance to a target acquired using a measuring technique such as LiDAR (Light Detection And Ranging). LiDAR is a technique of emitting a laser beam to a target and measuring the distance to the target, the shape of the target, and so forth, based on information of the reflected light. Therefore, it is possible to acquire, using LiDAR, three-dimensional point cloud data including the value of a distance to each point located on the surface of a target, and it is possible to use for grasping the shape of the land and the shape of a structure such as a building. However, three-dimensional point cloud data is not limited to being acquired using LiDAR, and may be acquired by measuring with any measuring device.

With reference to FIGS. 1 and 2, the state of acquisition of three-dimensional point cloud data using a LiDAR device will be described, and a situation in which a noise point cloud is likely to be generated in acquisition of three-dimensional point cloud data will also be described.

As shown in FIG. 1, a laser beam emitted by a LiDAR device A1 has a finite beam diameter and, depending on the direction of scanning by LiDAR, a situation arises in which the laser beam is emitted to an object at a different distance located at the edge portion or the like of another object. Here, parts denoted by symbols T1 and T2 represent measurement targets located on the front side and the back side of an object to be measured.

Then, the LiDAR device A1 emits a ranging pulse laser onto the targets T1 and T2. Symbols B1 and B2 in FIG. 1 denote regions illuminated by the ranging pulse laser emitted by the LiDAR device onto the targets T1 and T2, respectively. At this time, a plane denoted by symbol T3 shown in FIG. 1 is almost parallel to the line of sight, which is the emission direction of the laser beam by the LiDAR device A1, and is a blind spot for the LiDAR device A1, so that it is a region where a point cloud cannot be obtained in the first place by ranging by the LiDAR device A1. Symbol B3 shown in FIG. 1 denotes a region on the plane denoted by symbol T3, which is a region where the difference in distance to the measurement targets T1 and T2 on the front side and the back side arises.

In the situation as shown in FIG. 1, reflected pulse lights independently enter the LiDAR device A1 from the respective targets T1, T2, and T3, so that the received light intensity decreases. Then, since the ranging accuracy decreases due to the decrease in light intensity of the received pulse, a region around the region denoted by symbol B3 of the target T3 is a region in which a noise point cloud is likely to be generated. Moreover, since the beam diameter of the ranging pulse generally becomes larger as the distance from the LiDAR device A1 becomes longer, the ratio of appearance of a noise point cloud becomes higher as the ranging is performed at a farther distance. Point clouds obtained by the LiDAR device A1 are illustrated in FIG. 2. At this time, symbols P1, P2, and P3 shown in FIG. 2 schematically represent the point clouds of the measurement targets T1, T2, and T3, respectively. Then, symbol C1 shown in FIG. 2 shows the shape of the laser beam with the LiDAR device A1 as the apex and denotes a conical region. In this example embodiment, as described below, a point cloud that can be determined to be a three-dimensional noise point cloud is removed using the distributions of distance values of the point clouds within the conical region.

### Configuration

A point cloud processing apparatus 1 in this example embodiment is configured with one or a plurality of information processing apparatuses including an arithmetic logic unit and a memory unit. Then, as shown in FIG. 3, the point cloud processing apparatus 1 includes a point cloud clipping unit 11, a point cloud classifying unit 12, and a point cloud generating unit 13. The respective functions of the point cloud clipping unit 11, the point cloud classifying unit 12, and the point cloud generating unit 13 can be realized by the arithmetic logic unit executing a program for realizing the respective functions stored in the memory unit.

The point cloud clipping unit 11 has a function of accepting input of point cloud data from a point cloud input device, which is not shown, and clipping and extracting a point cloud within a specified three-dimensional region. As described with reference to FIGS. 1 and 2, point cloud data to be input is three-dimensional point cloud data including the value of a distance to a target measured with a measuring device such as the LiDAR device A1. For example, the point cloud clipping unit 11 specifies a cone-shaped region like a conical region having a certain solid angle with the LiDAR device A1 as the apex, and clips a point cloud. Meanwhile, a region to be specified may have any shape, and may be as a rectangular parallelepiped region with an infinite length in the distance direction or a spherical region.

The point cloud classifying unit 12 (classifying unit) receives point clouds from the point cloud clipping unit 11, performs clustering on the point clouds, and classifies the point clouds into at least one or more clusters so that each belongs to any of the clusters. In the method of clustering, for example, classification of point clouds is performed by a classification method such as the k-means method. More specifically, the classification method may be, for example, a classification method based on a Euclidean distance using the three-dimensional position information of a point cloud, or a classification method based on a distance in the line of sight with reference to the LiDAR device A1. In particular, in this example embodiment, a classification method based on the state of distribution of point clouds based on a histogram of distance values of point clouds with reference to the LiDAR device A1 is used.

An example of the histogram of distance values of point clouds is shown in FIG. 4. The histogram in FIG. 4 shows a histogram of distance values of the point clouds P1, P2, and P3 clipped by a conical region C1 in FIG. 2. The point cloud classifying unit 12 uses the histogram of the distance values to set the clusters of the point clouds in accordance with the distance values. For example, a point cloud in which the distance values are located within a predetermined range from each other and a point cloud in which the distance values are located consecutively are each set as one cluster. In the example of FIG. 4, the point clouds are classified into clusters denoted by symbols H11, H12, and H13, respectively, with distance values at which the frequency becomes 0 as boundaries. In the example shown in FIG. 2, the distances to the targets T1, T2, and T3 are different from each other, and the distance values in the respective point clouds are dense around the distances to the respective targets, so that the point clouds can be classified into the clusters H11, H12, and H13 as shown in FIG. 4. The cluster H11 may correspond to the target T1, the cluster H12 may correspond to the target T2, and the cluster H13 may correspond to the target T3.

The point cloud generating unit 13 (determining unit) receives the point clouds classified into the respective clusters from the point cloud classifying unit 12, and determines whether to adopt or reject the point clouds belonging to the respective clusters. That is to say, the point cloud generating unit 13 determines to adopt the point cloud belonging to the cluster as the point cloud of the target, or to reject, namely, remove as a noise point cloud. Moreover, in the case of adopting the cluster, the point cloud generating unit 13 may recalculate the three-dimensional position information and so forth of the point cloud and generate a new point cloud.

Specifically, for example, the point cloud generating unit 13 determines whether to adopt or reject a point cloud belonging to a cluster having been input in accordance with the manner of distribution of distance values in the point cloud of the cluster. Distance values of a point cloud show variation resulting from the ranging accuracy of the LiDAR device A1 and other measurement conditions, and the shape of the histogram of the distance values of the point cloud usually indicates a Gaussian distribution shape centered on the distance value to the measurement target. On the other hand, in a case where the result of ranging is calculated from a noise signal, the distance values show a random distribution, so that the shape of the histogram of the distance values of the point cloud indicates a constant frequency distribution regardless of the distance. For this reason, it is possible to, based on the shape of the histogram of the distance values of the point cloud, determine as the point cloud of the target and adopt or determine as a noise point cloud and reject.

In FIG. 4, the shape of the histogram of the distance values in the clusters H11 and H12 shows a Gaussian approximate curve with a peak. Therefore, the point cloud generating unit 13 determines that the clusters H11 and H12 having a Gaussian distribution shape in the histogram of the distance values are the clusters of the point clouds of the targets, and adopts the point clouds belonging to the clusters H11 and H12. On the other hand, in FIG. 4, the histogram of the distance values in cluster H13 has a constant frequency distribution shape. Therefore, the point cloud generating unit 13 determines that the cluster H13 is the cluster of the noise point cloud, and rejects the point cloud belonging to the cluster H13.

Further, the point cloud generating unit 13 may determine whether to adopt or reject a point cloud belonging to a cluster, for example, in accordance with whether the number of point clouds belonging to the cluster, namely, the frequency of distance value is equal to or more than a threshold value. Here, it is assumed that the number of point clouds classified into the cluster of the target is greater than the number of point clouds classified into the noise point cloud cluster. For this reason, in a case where a condition is satisfied that the number of point clouds included by a cluster is equal to or greater than a preset threshold value Th1, the point cloud generating unit 13 may adopt the point clouds included by the cluster. Moreover, in the histogram of distance values of point clouds as shown in FIG. 4, the point clouds included by the cluster of the target show the peak of frequency at a specific distance value. Therefore, in a case where a condition is satisfied in the histogram of the distance values of each cluster that the number of point clouds included in a width dR indicating the range of predetermined distance values within the cluster is equal to or greater than a threshold value Th2, the point cloud generating unit 13 may adopt the point clouds included by the cluster.

Further, in discrimination of a point cloud to adopt, due to the principle of LiDAR, a region behind the measurement target is a blind spot region, and a point cloud of an object existing within that region cannot be acquired. For this reason, the point cloud generating unit 13 may extract only a cluster that is closest to the LiDAR device A1 from among clusters determined to adopt as described above.

Thus, the point cloud generating unit 13 determines whether to adopt or reject a point cloud in each cluster using the histogram of distance values of point cloud data and the frequency of distance values. That is to say, the point cloud generating unit 13 determines whether a point cloud is that of a target or noise based on the distribution of distance values for each cluster, and the determination is facilitated.

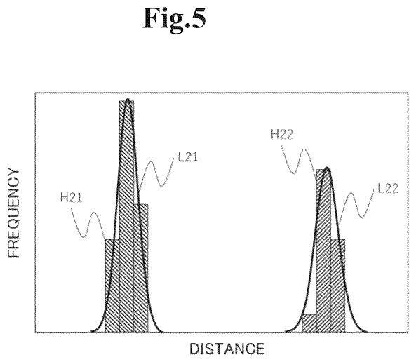

Further, the point cloud generating unit 13 may newly generate a point cloud from the point cloud belonging to the cluster determined to adopt. For example, the point cloud generating unit 13 may extract the center of gravity of the cluster as a representative point and generate a new point cloud. In a point cloud acquired by LiDAR, due to the ranging accuracy thereof, points may be generated around a distance at which a target actually exists. The distribution of the distance values of this point cloud generally shows a Gaussian distribution centered on the distance at which the object exists in the case of extraction at random. Therefore, in the case of recalculating the distance with the point cloud generating unit 13, it can be thought to adopt the average of distance values or the center of gravity of the point cloud or the Gaussian center position obtained by regression analysis on the extracted cluster. Thus, it can be expected that the accuracy of point cloud data obtained by LiDAR can be increased by performing regression analysis or extracting a representative value such as the average on the distribution of the point cloud and thereby calculating the coordinates of the point cloud to adopt. Consequently, for example, approximation curves L11 and L12 of the clusters H11 and H12 to adopt shown in FIG. 4 are expected to show Gaussian distributions with small variance such as approximation curves L21 and L22 shown in FIG. 5 by regenerating the point clouds.

### [Operation]

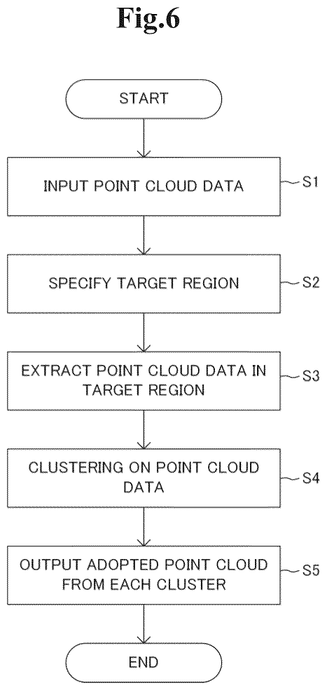

Next, the operation of the point cloud processing apparatus 1 illustrated above will be described mainly with reference to a flowchart of FIG. 6.

First, the point cloud clipping unit 11 accepts input of point cloud data from an input device, which is not shown (step S1). The point cloud data input at step S1 holds viewpoint information of the LiDAR device A1.

The point cloud clipping unit 11 specifies a region to clip a point cloud from the input point cloud data (step S2). Then, the point cloud clipping unit 11 extracts a point cloud located within the specified region and outputs to the point cloud classifying unit 12 (step S3). For example, as shown in FIG. 2, the point cloud clipping unit 11 specifies the cone-shaped region C1 with the LiDAR device A1 as its apex, and extracts a point cloud within the region C1.

The point cloud classifying unit 12 classifies the point clouds input from the point cloud clipping unit 11 into at least one or more clusters and outputs to the point cloud generating unit 13 (step S4). At this time, for example, using the histogram of distance values, the point cloud classifying unit 12 sets clusters for the point clouds in accordance with the distance values. Consequently, the point clouds can be classified into the clusters H11, H12, and H13 as shown in FIG. 4.

The point cloud generating unit 13 performs, on the classified point clouds input from the point cloud classifying unit 12, determination whether to adopt or reject the point clouds of the respective clusters. For example, the point cloud generating unit 13 determines, in accordance with the manner of distribution of the distance values of the input point clouds of the clusters, whether to adopt or reject the point clouds belonging to the clusters. As an example, in a case where the distance values of the point clouds form the histograms as shown in FIG. 4, the clusters H11 and H12 are determined to be clusters including the point clouds of the target because the clusters H11 and H12 have Gaussian distribution shapes, and the point clouds included by the clusters H11 and H12 are adopted. On the other hand, since the cluster H13 has a constant frequency distribution shape, the cluster H13 is determined to be a cluster including a noise point cloud, and the point cloud included by the cluster H13 is rejected. Then, the point cloud generating unit 13 performs calculation of a representative point on the point cloud included by the cluster to adopt, generates a new point cloud, and outputs the generated point cloud to an output device, which is not shown (step S5).

Thus, according to the point cloud processing apparatus 1 in this example embodiment, even if point clouds are dense within a region extracted by the point cloud clipping unit 11, it is possible to accurately remove point cloud data discriminated as a noise point cloud. Moreover, by performing calculation of position information on the point cloud data adopted by the point cloud generating unit 13, the ranging accuracy can be increased.

### Second Example Embodiment

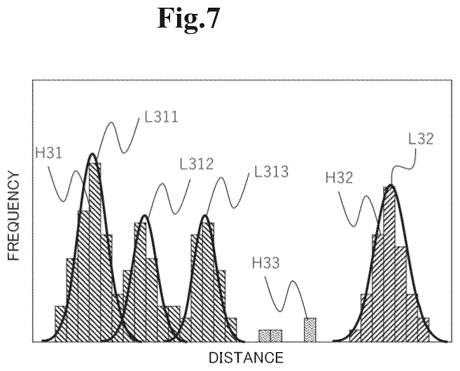

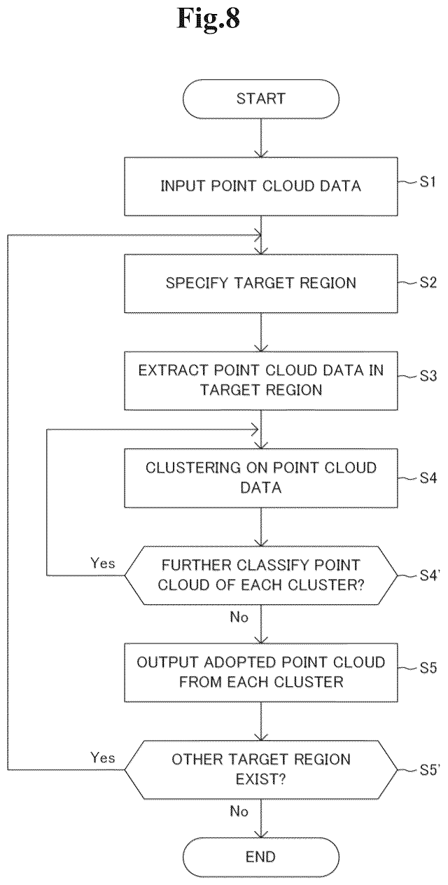

Next, a second example embodiment of the present disclosure will be described with reference to FIGS. 7 and 8. FIGS. 7 an 8 are views for describing the processing operation of a point cloud processing apparatus. Since the point cloud processing apparatus 1 in this example embodiment has almost the same configuration as that described in the first example embodiment illustrated above, a function of the point cloud processing apparatus 1 different from that in the first example embodiment illustrated above will be described below mainly with reference to a flowchart of FIG. 8.

The point cloud processing apparatus 1 in this example embodiment performs noise removal on the entire point cloud by applying the processing on a certain specific region described in the first embodiment to each part of the point cloud. Specifically, as in the first embodiment illustrated above, the point cloud clipping unit 11 first accepts input of point cloud data (step S1), specifies a region to clip a point cloud from the input point cloud data (step S2), and extracts a point cloud located within the specified region (step S3).

Subsequently, the point cloud classifying unit 12 classifies the point clouds input from the point cloud clipping unit 11 into at least one or more clusters (step S4). Here, the point clouds classified into clusters by the point cloud classifying unit 12 are classified into clusters at least one time or more. In the caser of a situation such as the point clouds classified into clusters by the point cloud classifying unit 12 are separated into a plurality of regions in terms of distance, clustering may be performed in more detail.

Here, an example of a histogram of distance values in a case where it is required to perform clustering two times, or more is shown in FIG. 7. FIG. 7 shows a case where point clouds are classified into three clusters H31, H32, and H33. At this time, in a case where a target located on the front side, which is a side close to the LiDAR device A1, shows a complicated structure, it is assumed that a distribution in which a number of Gaussian distributions overlap is shown. Therefore, in the cluster H31 located on the front side, the distribution shape, namely, the approximate curve of the histogram has a shape in which a plurality of Gaussian distributions overlap as indicated by L311, L312, and L313, respectively. Moreover, the cluster H32 corresponds to a point cloud of an object located on the back side, and the approximate curve of the histogram of distance values is as denoted by L32. The cluster H33 corresponds to a noise point cloud.

In the situation as illustrated above, it is possible to determine whether more detailed clustering is required based on the variance of the point cloud based on the ranging accuracy of LiDAR. This is because each Gaussian distribution represented by a point cloud obtained by reflection from a target shows dispersion corresponding to the ranging accuracy. For this reason, the point cloud classifying unit 12 performs more detailed classification by clustering for each cluster classified at step S4 in a case where the dispersion of the cluster is equal to or greater than a threshold value. Thus, in the case of determining that reclassification is required based on the distribution of distance values of point clouds included by classified clusters, the point cloud classifying unit 12 reclassifies the point cloud of the cluster into a plurality of clusters in more detail.

In the example of FIG. 7, the point cloud classifying unit 12 determines to perform more detailed clustering on the cluster H31 because the variance in the histogram is equal to or greater than the threshold value (Yes at step S4′), the point cloud classifying unit 12 performs clustering again on the point cloud included by the cluster H31 (step S4). The point cloud classifying unit 12 performs reclassification by changing the criteria for clustering. For example, the point cloud classifying unit 12 sets a point cloud located within a narrower range of distance values in the histogram of distance values into one cluster. Thus, the cluster H31 shown in FIG. 7 is reclassified into clusters having Gaussian distribution shapes indicated by approximate curves L311, L312, and L313. In a case where the value of the variance of the point cloud after clustering is less than the threshold value and it is determined that no more clustering is required (No at step S4), the point cloud classifying unit 12 outputs the point cloud after clustering to the point cloud generating unit 13.

Subsequently, the point cloud generating unit 13 performs determination whether to adopt or reject the point cloud of each cluster on the point clouds after clustering input from the point cloud classifying unit 12, and outputs the point cloud of the cluster to adopt (step S5).

After that, when a series of operations at steps S2 to S5 ends, the point cloud processing apparatus 1 checks whether any other region that requires point cloud processing is left and, when left, again specifies the different region and executes the same processing as mentioned above and thereby performs point cloud processing on each part of input point cloud.

### Third Example Embodiment

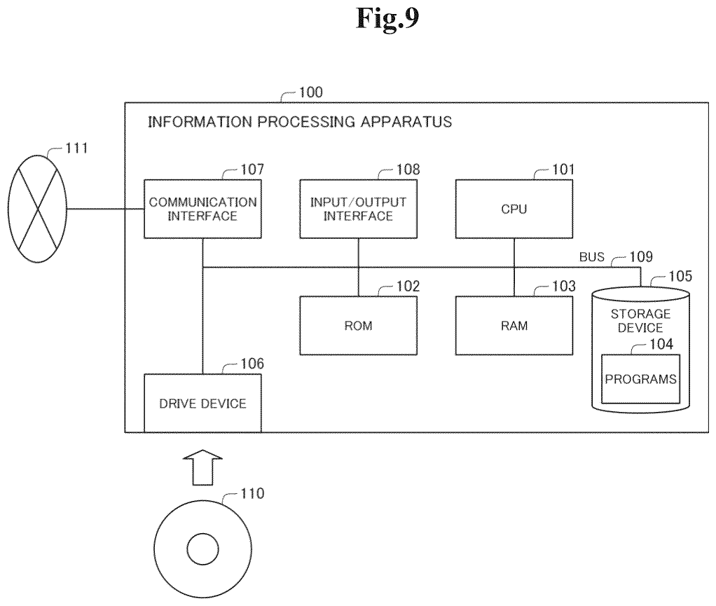

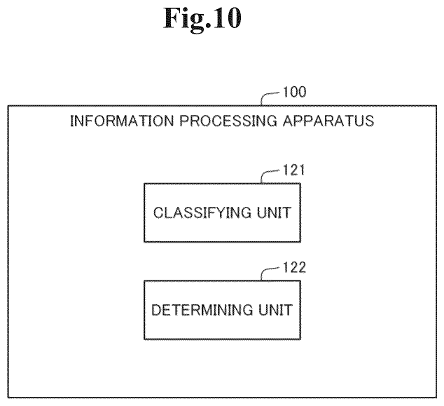

Next, a third example embodiment of the present disclosure will be described with reference to FIGS. 9 and 10. FIGS. 9 and 10 are block diagrams showing the configuration of an information processing apparatus in the third example embodiment. In this example embodiment, the overview of the configuration of the point cloud processing apparatus described in the above example embodiments is shown.

First, with reference to FIG. 9, the hardware configuration of an information processing apparatus 100 in this example embodiment will be described. The information processing apparatus 100 is configured with a general information processing apparatus and, as an example, has the following hardware configuration including,
a CPU (Central Processing Unit) 101 (arithmetic logic unit),
a ROM (Read Only Memory) 102 (memory unit),
a RAM (Random Access Memory) 103 (memory unit),
programs 104 loaded to the RAM 103,
a storage device 105 storing the programs 104,
a drive device 106 reading from and writing into a storage medium 110 outside the information processing apparatus,
a communication interface 107 connecting to a communication network 111 outside the information processing apparatus,
an input/output interface 108 performing input/output of data, and
a bus 109 connecting the respective components.

FIG. 9 shows an example of the hardware configuration of the information processing apparatus serving as the information processing apparatus 100, and the hardware configuration of the information processing apparatus is not limited to the abovementioned one. For example, the information processing apparatus may be configured with part of the abovementioned configuration, for example, without the drive device 106. Moreover, the information processing apparatus can include, instead of the abovementioned CPU, a GPU (Graphic Processing Unit), a DSP (Digital Signal Processor), a MPU (Micro Processing Unit), a FPU (Floating point number Processing Unit), a PPU (Physics Processing Unit), a TPU (Tensor Processing Unit), a quantum processor, a microcontroller, or a combination thereof.

Then, the information processing apparatus 100 can build and include a classifying unit 121 and a determining unit 122 shown in FIG. 10 by acquisition and execution of the programs 104 by the CPU 101. The programs 104 are, for example, stored in advance in the storage device 105 and the ROM 102, and loaded to the RAM 103 and executed by the CPU 101 as necessary. Moreover, the programs 104 may be provided to the CPU 101 via the communication network 111, or may be stored in advance in the storage medium 110 and read out and provided by the drive device 106 to the CPU 101. However, the classifying unit 121 and the determining unit 122 mentioned above may be built with a dedicated electronic circuit for realizing these units.

The classifying unit 121 classifies three-dimensional point cloud data including distance values to a target in a predetermined region into one or more clusters based on the distance values. The determining unit 122 determines the cluster to adopt based on a distribution of the distance values of the three-dimensional point cloud data.

With the configuration as described above, the present disclosure enables accurate removal of point cloud data discriminated as a noise point cloud even when the point clouds are dense by determining a cluster to adopt based on the distribution of the distance values of three-dimensional point cloud data.

The abovementioned program can be stored using various types of non-transitory computer-readable mediums and provided to a computer. The non-transitory computer-readable mediums include various types of tangible storage mediums. Examples of the non-transitory computer-readable mediums include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory)). The program may also be provided to a computer by various types of transitory computer-readable mediums. Examples of the transitory computer-readable mediums include an electric signal, an optical signal, and an electromagnetic wave. The transitory computer-readable medium can provide the program to a computer via a wired communication path such as an electric wire and an optical fiber or via a wireless communication path.

Although the present disclosure has been described above with reference to the above example embodiments and so forth, the present disclosure is not limited to the example embodiments illustrated above. The configurations and details of the present disclosure can be changed in various manners that can be understood by one skilled in the art within the scope of the present disclosure. Moreover, at least one or more functions of the functions of the classifying unit 121 and the determining unit 122 illustrated above may be executed by an information processing apparatus installed in any place on the network and connected, that is, may be executed by so-called cloud computing.

### <Supplementary Notes>

The whole or part of the example embodiments disclosed above can be described as the following supplementary notes. The overview of the configurations of an information processing apparatus, an information processing method, and a program in the present disclosure will be described below. However, the present disclosure is not limited to the following configurations.

### (Supplementary Note 1)

An information processing apparatus comprising:
at least one memory storing processing instructions; and
at least one processor configured to execute the processing instructions to:
classify three-dimensional point cloud data including distance values to a target in a specified region into one or more clusters based on the distance values; and
determine the cluster to adopt based on a distribution of the distance values of the three-dimensional point cloud data included by the cluster obtained by the classification.

### (Supplementary Note 2)

The information processing apparatus according to Supplementary Note 1, wherein the at least one processor is configured to execute the processing instructions to
determine the cluster to adopt based on a histogram of the distance values of the three-dimensional point cloud data included by the cluster obtained by the classification.

### (Supplementary Note 3)

The information processing apparatus according to Supplementary Note 2, wherein the at least one processor is configured to execute the processing instructions to determine the cluster to adopt based on a shape of the histogram.

### (Supplementary Note 4)

The information processing apparatus according to Supplementary Note 3, wherein the at least one processor is configured to execute the processing instructions to
determine, as the cluster to adopt, the cluster that the shape of the histogram is a Gaussian distribution shape.

### (Supplementary Note 5)

The information processing apparatus according to any of Supplementary Notes 1 to 4, wherein the at least one processor is configured to execute the processing instructions to
determine the cluster to adopt based on a frequency of the distance values of the three-dimensional point cloud data included by the cluster obtained by the classification.

### (Supplementary Note 6)

The information processing apparatus according to Supplementary Note 5, wherein the at least one processor is configured to execute the processing instructions to
determine, as the cluster to adopt, the cluster that the frequency of the distance values of the three-dimensional point cloud data included by the cluster obtained by the classification is equal to or greater than a preset threshold value.

### (Supplementary Note 7)

The information processing apparatus according to any of Supplementary Notes 1 to 6, wherein the at least one processor is configured to execute the processing instructions to
calculate a representative value of the distance values of the three-dimensional point cloud data included by the cluster to adopt, based on the distance values.

### (Supplementary Note 8)

The information processing apparatus according to any of Supplementary Notes 1 to 7, wherein the at least one processor is configured to execute the processing instructions to
reclassify the three-dimensional point cloud data included by the cluster obtained by the classification into a plurality of clusters based on the distribution of the distance values of the three-dimensional point cloud data included by the cluster; and
determine the cluster to adopt based on the distribution of the distance values of the three-dimensional point cloud data included by the cluster obtained by the reclassification.

### (Supplementary Note 9)

An information processing method comprising:
classifying three-dimensional point cloud data including distance values to a target in a specified region into one or more clusters based on the distance values; and
determining the cluster to adopt based on a distribution of the distance values of the three-dimensional point cloud data included by the cluster obtained by the classification.

### (Supplementary Note 10)

A computer program comprising instructions for causing a computer to execute processes to:
classify three-dimensional point cloud data including distance values to a target in a specified region into one or more clusters based on the distance values; and
determine the cluster to adopt based on a distribution of the distance values of the three-dimensional point cloud data included by the cluster obtained by the classification.

### DESCRIPTION OF REFERENCE NUMERALS

1 point cloud processing apparatus
11 point cloud clipping unit
12 point cloud classifying unit
13 point cloud generating unit
100 information processing apparatus
101 CPU
102 ROM
103 RAM
104 programs
105 storage device
106 drive device
107 communication interface
108 input/output interface
109 bus
110 storage medium
111 communication network
121 classifying unit
122 determining unit

1. An information processing apparatus comprising:
at least one memory storing processing instructions; and
at least one processor configured to execute the processing instructions to:
classify three-dimensional point cloud data including distance values to a target in a specified region into one or more clusters based on the distance values; and
determine the cluster to adopt based on a distribution of the distance values of the three-dimensional point cloud data included by the cluster obtained by the classification.

2. The information processing apparatus according to claim 1, wherein the at least one processor is configured to execute the processing instructions to
determine the cluster to adopt based on a histogram of the distance values of the three-dimensional point cloud data included by the cluster obtained by the classification.

3. The information processing apparatus according to claim 2, wherein the at least one processor is configured to execute the processing instructions to
determine the cluster to adopt based on a shape of the histogram.

4. The information processing apparatus according to claim 3, wherein the at least one processor is configured to execute the processing instructions to
determine, as the cluster to adopt, the cluster that the shape of the histogram is a Gaussian distribution shape.

5. The information processing apparatus according to claim 1, wherein the at least one processor is configured to execute the processing instructions to
determine the cluster to adopt based on a frequency of the distance values of the three-dimensional point cloud data included by the cluster obtained by the classification.

6. The information processing apparatus according to claim 5, wherein the at least one processor is configured to execute the processing instructions to
determine, as the cluster to adopt, the cluster that the frequency of the distance values of the three-dimensional point cloud data included by the cluster obtained by the classification is equal to or greater than a preset threshold value.

7. The information processing apparatus according to claim 1, wherein the at least one processor is configured to execute the processing instructions to
calculate a representative value of the distance values of the three-dimensional point cloud data included by the cluster to adopt, based on the distance values.

8. The information processing apparatus according to claim 1, wherein the at least one processor is configured to execute the processing instructions to
reclassify the three-dimensional point cloud data included by the cluster obtained by the classification into a plurality of clusters based on the distribution of the distance values of the three-dimensional point cloud data included by the cluster; and
determine the cluster to adopt based on the distribution of the distance values of the three-dimensional point cloud data included by the cluster obtained by the reclassification.

9. An information processing method comprising:
classifying three-dimensional point cloud data including distance values to a target in a specified region into one or more clusters based on the distance values; and
determining the cluster to adopt based on a distribution of the distance values of the three-dimensional point cloud data included by the cluster obtained by the classification.

10. A non-transitory computer-readable storage medium storing a program comprising instructions for causing a computer to execute processes to:
classify three-dimensional point cloud data including distance values to a target in a specified region into one or more clusters based on the distance values; and
determine the cluster to adopt based on a distribution of the distance values of the three-dimensional point cloud data included by the cluster obtained by the classification.
